(19) United States
(12) Patent Application Publication
(10) Pub. No.: US 2022/0083924 A1
(43) Pub. Date: Mar. 17, 2022

(54) System and Method for Measuring Social Cost of Ridesharing Service

(71) Applicant: Mitsubishi Electric Research Laboratories, Inc., Cambridge, MA (US)

(72) Inventors: Uros Kalabic, Jamaica Plain, MA (US); Tsz-Chun Michael Chiu, Toronto (CA)

(73) Assignee: Mitsubishi Electric Research Laboratories, Inc., Cambridge, MA (US)

(21) Appl. No.: 17/022,154

(22) Filed: Sep. 16, 2020

(51) Int. Cl. G06Q 10/04; H04L 9/06; G06Q 50/30; G06Q 10/02; G06Q 30/02; G08G 1/00

(52) U.S. Cl. CPC G06Q 10/04; H04L 9/0618; G06Q 50/30; H04L 2209/38; G06Q 30/0215; G08G 1/202; G06Q 10/02

(57) ABSTRACT

A system for measuring a social cost of a ridesharing service to transport passengers requesting transportation from their corresponding pick-up to destination locations is provided. The system includes an input interface to accept the pickup and destination locations, information about traffic in a region including the pickup and destination locations, and a ridesharing path plan estimated by the ridesharing service for a vehicle to transport the passengers; a processor configured to: estimate a first delay in the traffic caused by the vehicle traveling along the ridesharing path plan; simulate an individual transportation path plan for each of the passengers to estimate a second delay in the traffic caused by a combination of the individual transportation path plans; and determine the social cost of the ridesharing service based on a difference between the first and second delays; and an output interface configured to output the social cost of the ridesharing service.

### TECHNICAL FIELD

The present disclosure generally relates to field of vehicle ridesharing, and more specifically to a system and method for measuring a social cost of a ridesharing service.

### BACKGROUND

Ridesharing (also carpooling, car-sharing, and lift-sharing) is the sharing of car journeys so that more than one person travels in a car, and prevents the need for others to have to drive to a location themselves. By having more people using one vehicle, ridesharing reduces each person's travel costs such as: fuel costs, tolls, and the stress of driving. Ridesharing is potentially a more environmentally friendly and sustainable way to travel as sharing journeys can reduce air pollution, carbon emissions, traffic congestion on the roads, and the need for parking spaces. In recent years, ridesharing has revolutionized the mobility landscape and provided a novel way for people to access mobility. However, ridesharing may also lead to unwanted situations. For instance, ridesharing leads to the undesirable phenomenon of increased demand for unproductive transportation, i.e., deadheading. Deadheading is a situation where a rideshare vehicle heads to a pick-up location without passengers. This results in increased use of roads by unproductive transportation that may not serve any useful purpose.

As such, ridesharing service can both positively or negatively affect society. The total sum of all individuals' costs is referred to as the social cost. The social cost may include the total duration of all trips, average passenger convenience, economic costs, and pollution, among others.

Accordingly, it is an object of some embodiments to provide a system and a method for estimating a social cost of ridesharing services.

### SUMMARY

It is an object of some embodiments to provide a system and a method for estimating a social cost of ridesharing services. Additionally, or alternatively, it is an object of some embodiments to provide regulation of the ridesharing services to mitigate the social costs of ridesharing.

When a ridesharing passenger requests a rideshare vehicle for transportation, additional demand is created to the passenger's current location. This causes a ridesharing vehicle to lengthen an already existing trip, or perhaps worse, it causes deadheading, which is transportation without any passenger. In any case, additional transportation demand creates additional traffic delay without providing productive transportation to satisfy actual demand of the ridesharing passenger. It is an object of some embodiments to improve traffic by allowing ridesharing, such as carpooling that allow multiple ridesharing passengers to efficiently share the rideshare transportation. Such ridesharing may reduce the number of vehicles servicing a given demand for transportation. In this way, the reduction in the number of vehicles may improve the flow of traffic.

Some embodiments are based on the recognition that a social cost may be estimated based on negative externalities (e.g. pollution emissions) of the ridesharing services. Specifically, the negative externalities may be evaluated based on a difference between productive and unproductive demand for mobility that is caused by ridesharing. The productive demand may serve a social benefit serving transportation to passengers. The unproductive demand may cause an unnecessary cost to society. It is the object of some embodiments to balance unproductive transportation with an increase in productive transportation. To that end, the social cost may be evaluated by balancing the unproductive and productive transportation. In some embodiments, the balance in the unproductive and productive transportation may be achieved by comparing the actual social cost of transportation with ridesharing to a simulated social cost of transportation without ridesharing.

Some embodiments are based on the realization that the social cost may be viewed as a delay on a road caused by the motion of a vehicle rather than by the cost of actual transportation, such as fuel consumption. In such a manner, the social cost can be estimated from the outside of the vehicle transportation by its effect on others, which is consistent with the notion of social interaction. For example, the vehicle may be weighted in a reversed proportion to a number of passengers that may be transported by the vehicle. For example, the vehicle moves to pick up a passenger from a pick-up location. In such a scenario, the vehicle carries no passengers. The vehicle may be an automated-vehicle, a semi-automated, or manually operated vehicle. In such cases, the driver may not be counted as a passenger of the vehicle. When the vehicle carries no passenger, the weight of the vehicle is at maximum, e.g., equals to one. When the vehicle is carrying one passenger the weight may be low. However, the weight of the vehicle with one passenger may be higher than the weight of the vehicle with more than one passenger, e.g. two passengers. In some embodiments, a weighted distribution of the vehicle of an individual transportation path plan of a set of passengers may be simulated.

To that end, the weight of the vehicle is determined for each road or link of a road to provide a weighted delay of the ridesharing service. In some embodiments, the weighted delay caused by the ridesharing service of each vehicle may be estimated, as different links may have different weights. The weighted delay of the ridesharing service may be compared with the delay of individual but productive transportation of each passenger. Indeed, if a passenger instead of requesting a ridesharing service would use his/her personal vehicle to reach a desired destination, that transportation would always be productive, i.e., have no roads with weight corresponding to zero passengers, but also would not have of the benefit of decreasing weight further due to transportation of multiple passengers at once.

Some embodiments are based on a recognition that when a ridesharing company receives the request for the transportation for the passenger, the ridesharing company estimates a route for the transportation based on the request. The ridesharing company may optimize the route that the vehicle may travel to service multiple passengers. To that end, the route may include a transportation path plan that is common for providing ridesharing transportation to multiple passengers. Such a transportation path plan is referred to as a ridesharing path plan. This estimated ridesharing path plan may differ based on unproductive transportation to pick up the passenger. The ridesharing path plan may have a negative impact on the society. To that end, in some embodiments, an individual path plan of one or more passengers may be simulated independently. This individual path plan may differ from the ridesharing path plan. In some embodiments, the ridesharing path plan and individual path plan may differ in terms of a shorter route. For example, in some implementations, the individual path plan is the shortest route connecting pickup and destination locations. In some alternative embodiments, the ridesharing path plan and individual path plan may differ in terms of a faster route. For example, the individual path plan is the fastest route that may be selected by people traveling on their own.

Additionally, or alternatively, some embodiments are based on the recognition that in some situations, by not following a selfish path, an uncooperative vehicle may achieve its individual driving objective better than by following the selfish path. Specifically, this statement is correct only when enough vehicles cooperate. However, some embodiments are based on realization that when the traffic includes the cooperative vehicles that are guaranteed to pursue the common objective, the selfish path of the uncooperative vehicle may be suboptimal for the uncooperative vehicles. To that end, with the presence of the cooperative vehicles on the roads pursuing the common objective, the individual objective for each uncooperative vehicle represents the worst-case scenario for achieving the common objective of the cooperative vehicles as well as to achieve the individual objectives of the uncooperative vehicles. In other words, in a case where the common objective is to minimize average time spent in traffic, the deviation of the uncooperative vehicles from their selfish paths does not jeopardize the achievement of the common objective for cooperative vehicles. To that end, it is realized that if only cooperative vehicles are cooperative according to the partially social Nash equilibrium considering a combination of common and individual objectives, the movement of both the cooperative and uncooperative vehicles may converge to the allocation defined by the partially social Nash equilibrium even if only cooperative vehicles are directly cooperative. The Nash equilibrium may be based on delay functions indicative of delays on different path plans for transportation. In different embodiments, delay on a plan path may be defined by a linear or a nonlinear function. In some example embodiments, the Nash equilibrium may be implemented for quantifying the positive effect of ridesharing services in the transportation service. The positive effect of the ridesharing services may be quantified by solving an optimization problem using the Nash equilibrium. The Nash equilibrium solves the optimization problem to provide a solution for an unexpected distribution of the flow of vehicle in a traffic network and measure a social cost absence of ridesharing service.

Various embodiments estimate the social cost that may be used in different ways. In some embodiments, the social cost may be used for traffic control. The traffic control based on the social cost may assist a ridesharing company in providing transportation service to passengers. In an example embodiment, the traffic control may assist the ridesharing company in selecting a vehicle and/or selecting road segments to service the transportation. Additionally, or alternatively, in some embodiments, the social cost may be used for arbitration to prevent the ridesharing company to add an unreasonable cost to the society. Additionally, or alternatively, in some embodiments, the social cost may be used for mobility regulation to balance social costs imposed by the ridesharing company on society. In some example embodiments, a cap-and-trade approach may be used for mobility regulation. In a cap-and-trade approach, a cap on ridesharing service may be set for regulating limits and allowances of ridesharing transportation. The cap may be an aggregation of social costs of road segments determined in a virtual environment, such as a simulated environment.

Accordingly, one embodiment discloses a system for measuring the social cost of a ridesharing service to transport a set of passengers comprising one or more passengers requesting transportation from different pickup locations to different destination locations. The system includes an input interface configured to accept each of: the pickup and destination locations for the set of passengers, information about traffic in a region including the accepted pickup and destination locations, and a ridesharing path plan estimated by the ridesharing service for a vehicle to transport the set of passengers between their corresponding pickup and destination locations. The system also includes a processor configured to: estimate a first delay in the traffic caused by the vehicle traveling along ridesharing path plan estimated by the ridesharing service to transport the set of passengers; simulate an individual transportation path plan of each of the set of passengers between their corresponding pickup and destination locations to estimate a second delay in the traffic caused by a combination of the individual transportation path plan of each of the set of passengers based on the simulation; and determine the social cost of the ridesharing service based on a difference between the first delay and the second delay. The system further includes an output interface configured to output the social cost of the ridesharing service.

Another embodiment discloses a computer-implemented method for measuring a social cost of a ridesharing service to transport a passenger requesting transportation from a pickup location to a destination location. The computer-implemented method includes accepting each of: pickup and destination locations for more than one passengers in the plurality of passengers, information about traffic in a region including the accepted pickup and destination locations, and a first path plan estimated by the ridesharing service for a vehicle to transport the more than one passengers between their corresponding pickup and destination locations. The method includes estimating a first delay in the traffic caused by the vehicle traveling along the first path plan estimated by the ridesharing service to transport the passengers. The method includes simulating an individual transportation path plan of each of the passengers between their corresponding pickup and destination locations for estimating a second delay in the traffic caused by a combination of individual transportation path plan of each of the passengers. The method includes determining the social cost of the ridesharing service based on a difference between the first delay and the second delay. The method further includes outputting the social cost of the ridesharing service.

Further features and advantages will become more readily apparent from the following detailed description when taken in conjunction with the accompanying drawings.

### BRIEF DESCRIPTION OF THE DRAWINGS

The present disclosure is further described in the detailed description which follows, in reference to the noted plurality of drawings by way of non-limiting examples of exemplary embodiments of the present disclosure, in which like reference numerals represent similar parts throughout the several views of the drawings. The drawings shown are not necessarily to scale, with emphasis instead generally being placed upon illustrating the principles of the presently disclosed embodiments.

FIG. 1A shows an environmental representation of a ridesharing service to transport a set of passengers, according to some embodiments of the present disclosure.

FIG. 1B illustrates a scenario depicting a ridesharing service provided by the vehicle to transport the set of passengers, according to some example embodiments of the present disclosure.

FIG. 1C illustrates a scenario depicting a ridesharing service provided by the vehicle to transport the set of passengers, according to some other example embodiments of the present disclosure.

FIG. 1D shows a schematic representation depicting measurement of social cost, according to some embodiments of the present disclosure.

FIG. 1E shows a block diagram of the system for measuring social cost of a ridesharing service, according to some embodiments of the present disclosure.

FIG. 2 shows a representation depicting measurement of the social cost of the ridesharing service, according to some example embodiments of the present disclosure.

FIG. 3 shows a representation depicting measurement of the social cost of the ridesharing service, according to some other example embodiments of the present disclosure.

FIG. 4 shows a tabular representation depicting a social cost of the ridesharing service, according to some example embodiments of the present disclosure.

FIG. 5 shows a tabular representation depicting credit or debit for the ridesharing service, according to some example embodiments of the present disclosure.

FIG. 6 shows a representation depicting credit/debit transaction for ridesharing by a distributed ledger blockchain system, according to some example embodiments of the present disclosure.

FIG. 7 shows a method flow diagram for the credit/debit transactions by the distributed ledger blockchain system, according to some example embodiments of the present disclosure.

FIG. 8A shows a sequence flow diagram depicting implementation of the system, according to some example embodiments of the present disclosure.

FIG. 8B illustrates a representation depicting an exchange of credits/debits for the ridesharing service, according to some example embodiments of the present disclosure.

FIG. 8C illustrates a use case implementation of the system, according to some other example embodiments of the present disclosure.

FIGS. 9A and 9B shows a method flow for measuring social cost of a ridesharing service by the system, according to some other example embodiments of the present disclosure.

FIG. 10 shows an overall block diagram of the system, according to some example embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

### Overview

The proposed system enables measurement of social cost of ridesharing services. The measured social cost may be used for regulation of the ridesharing services. The regulation of the ridesharing service may contribute in improvement of traffic. Moreover, the regulation may incentivize the ridesharing services that may help in the traffic improvement.

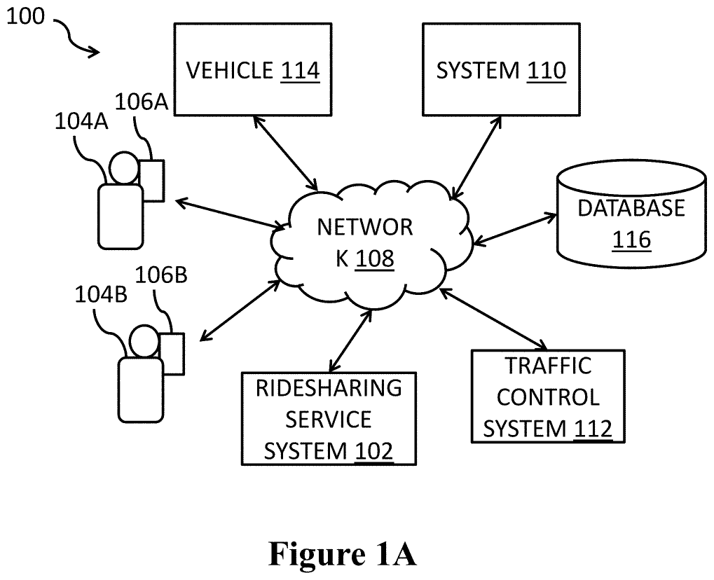

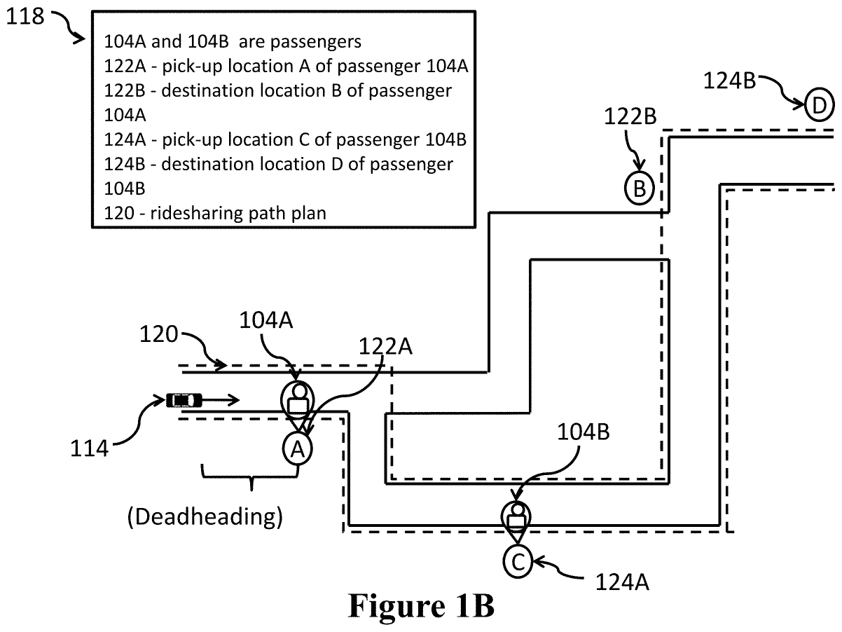

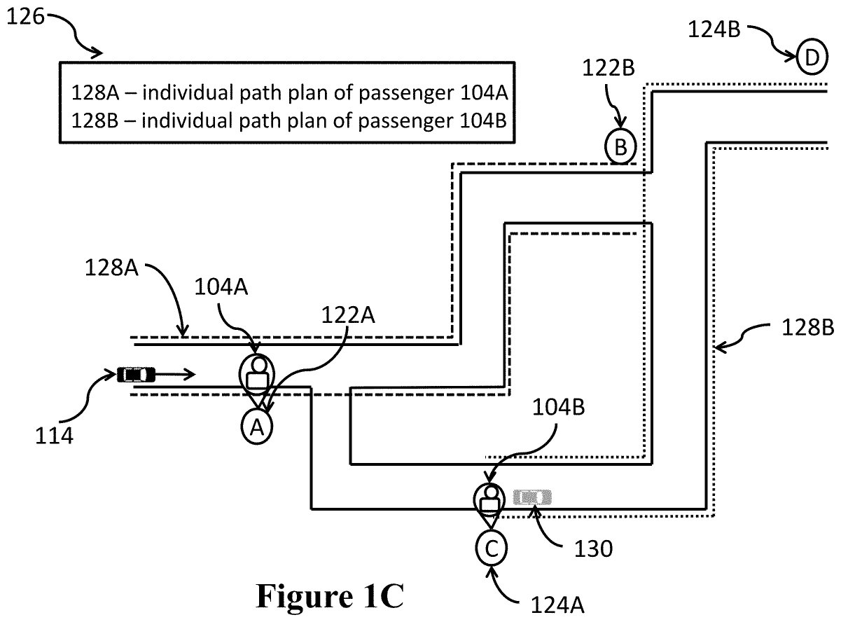

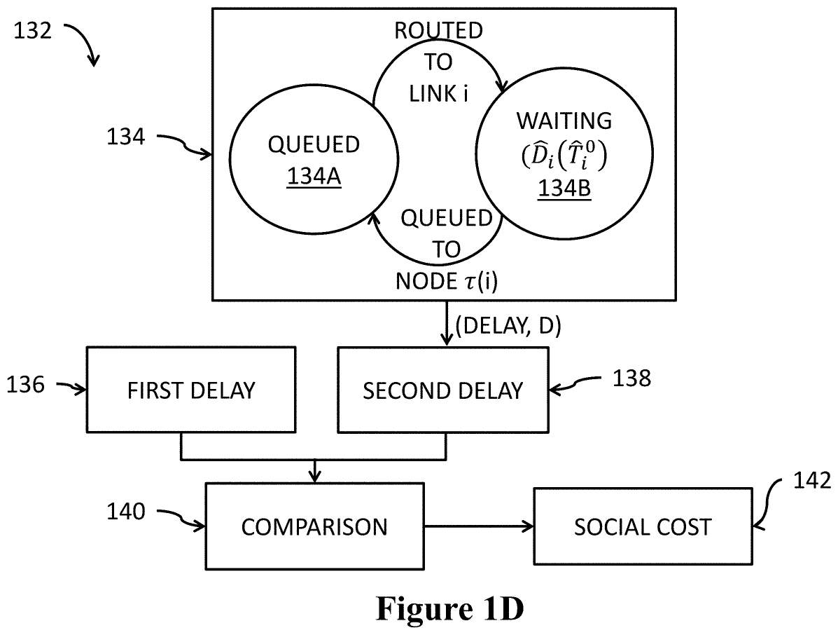

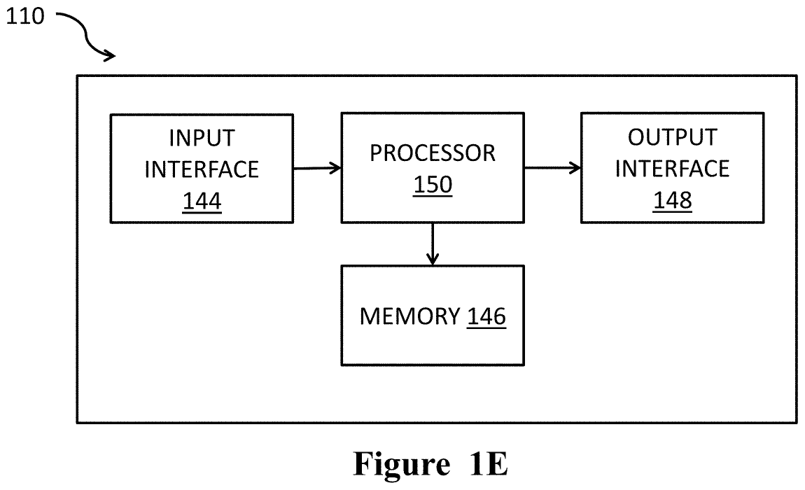

FIG. 1A shows a schematic 100 of operation of a ridesharing service system 102 to transport a set of passengers, such as a passenger 104A and a passenger 104B, according to some embodiments of the present disclosure. In an illustrative example scenario, the passenger 104A may send a transportation request to the ridesharing service system 102, using an electronic device 106A. In a similar manner, the passenger 104B may also send a transportation request to the ridesharing service system 102 using an electronic device 106B. Some of the non-limiting examples of the electronic devices 106A and 106B may include a computer smartphone, a laptop, a smartphone, phablet and/or a portable hand-held device. Each of the electronic devices 106A and 106B may include an application interface hosted by the ridesharing service system 102. Each of the passengers 104A and 104B provides their corresponding pick-up locations and drop-locations via the application interface and sends the transportation request. The ridesharing service system 102 may select a vehicle, such as a vehicle 114 for the set of passengers 104A and 104B. Some of the non-limiting examples of the vehicle 114 may include an automatic vehicle, a semi-automatic vehicle or a manually-operated vehicle.

In some example embodiments, the vehicle 114 may be selected based on nearest distance measurement to the pick-up location of the passenger 104A or the passenger 104B. For instance, the vehicle 114 may be located within 5 kilometers (kin) of distance from the pick-up location of the passenger 104A. Further, the ridesharing service system 102 may estimate a ridesharing path plan between the pick-up locations and the drop locations of the passengers 104A and 104B. In some example embodiments, the ridesharing service system 102 may access, via a network 108, real-time traffic information from a traffic control system 112 for the estimation of the ridesharing path plan. The ridesharing service system 102 may share the estimated ridesharing path plan with the vehicle 114. In some embodiments, the ridesharing path plan may be stored in a database 116.

When the vehicle 114 starts to move towards the pick-up location of the passenger 104, the vehicle 114 may have no passenger. This leads to a phenomenon of deadheading, which is an additional demand for an unproductive transportation. Such deadheading may contribute in negative externalities to environment. The scenario of deadheading leading to unproductive transportation is described with reference to FIGS. 1B and 1C.

FIG. 1B illustrates a scenario 118 depicting a ridesharing service provided by the vehicle 114 to transport the set of passengers 104A and 104B, according to some example embodiments of the present disclosure. As shown in FIG. 1B, the vehicle 114 moves towards a pick-up location 122A (i.e., location A) of the passenger 104A, without any passenger in the vehicle 114. The destination location of the passenger 104A is at location 122B (i.e., location B). The vehicle 114 also receives a transport request from the passenger 104B, which is at a pick-up location 124A (i.e., location C). The vehicle 114 may receive the transport request of the passenger 104B, while moving towards the pick-up location 122A or while transporting the passenger 104A towards the destination location 122B. The destination of the passenger 104B is at a destination location 124B (i.e., location D). The ridesharing service may traverse in a ridesharing path plan 120 that covers corresponding pick-up locations 122A and 124A (i.e., locations A and C) and corresponding drop locations 122B and 124B (i.e., locations B and D) of the passengers 104A and 104B. Such situation may happen, when the ridesharing service system 102 assigns the vehicle 114 for providing the transport service to both the passengers 104A and 104B.

However, there may be times that the ridesharing path plan 120 may be optimal for the transportation. The ridesharing path plan 120 may have negative externalities that impact the society. To that end, an individual path plan for each of the passengers 104A and 104B may be simulated by the system 110, which are shown and described next with reference to FIG. 1C.

FIG. 1C illustrates a scenario 126 depicting simulated individual transportation path plans, such as an individual path plan 128A and an individual transportation path plan 128B for of a set of passengers, such as the corresponding passengers 104A and 104B, according to some other example embodiments of the present disclosure. In some example embodiments, the ridesharing service system 102 may send the transportation requests of the corresponding passengers 104A and 104B to the system 110. The system 110 simulates the individual path plans 128A and 128B for each of the passengers 104A and 104B, upon receipt of the corresponding transportation requests. As shown in FIG. 1C, the passenger 104A may travel via the individual path plan 128A between the pick-up location 122A to the destination location 122B, i.e., from location A to location B. In a similar manner, the passenger 104B may travel the individual path plan 128B between the pick-up location 124A to the destination location 124B, i.e. location C to location D. The passenger 104B may take the individual path plan 128B via a vehicle 130.

In one example embodiment, the individual path plans 128A and 128B may be simulated using a deterministic simulator algorithm. For instance, the deterministic simulator algorithm may be used to track states of each of the transportation requests, implement delays and perform state transitions of each of the transportation requests. Each of the individual path plans 128A and 128B may impact the negative externalities of ridesharing services. To that end, social cost of the ridesharing services is measured by the system 110. The system 110 may measure social cost in each of the individual path plans 128A and 128B. The measurement of social cost is described next with reference to FIG. 1D.

FIG. 1D shows a schematic representation 132 depicting measurement of social cost, according to some embodiments of the present disclosure. In some example embodiments, the system 110 determines minimum-path routes as the individual path plans 128A and 128B for each transportation request of the corresponding passengers 104A and 104B. For each of the individual path plans 128A and 128B, a minimum-cost path is determined. The minimum-cost path provides a routing matrix, R: V×ε×V→ [symbol] for a link i (e.g., the individual path plan 128A and the individual path plan 128B) with an origin and destination pair (j^{s},j^{f}) (e.g., the locations 122A and 122B of the individual path plan 128A and the locations 124A and 124B of the individual path plan 128B), i*=arg min_{i∈ε:σ(I)=j}_{^{s}}Rⱼ_{^{s}}ᵢⱼ_{^{f}}. A vehicle on the link i, e.g., the vehicle 114 on the individual path plan 128A and the vehicle 130 on the individual path plan 128B, updates the cost of corresponding link to Dᵢ(\hat{X}ᵢ(\hat{T}ᵢ⁰)+1).

In some example embodiments, when the system 110 receives the transportation requests of the passengers 124A and 124B, each of the transportation requests undergoes a state transition 134. Each of the transportation requests has states, such as queued state 134A and waiting state 134B. When each of the transportation requests is in the queued state 134A (e.g., at node j), each of the transportation requests is routed to a link i satisfying σ(i)=j according to the minimum-distance path. The transportation requests in the queued state 134A are transitioned into the waiting state 134B for a delay equal to delay on the link (e.g., the locations 122A and 122B and the locations 124A and 124B), (\hat{D}ᵢ (\hat{T}ᵢ⁰) at current time \hat{T}ᵢ⁰. After the duration of the delay, each of the transportation requests is placed back into the queue state 134A at node τ(i) and the process repeats until the transportation requests reach the destination. The delays for each of the transportation requests of the corresponding passengers 104A and 104B may be determined by the system 110 at the time of routing the individual path plans 128A and 128B.

The delay (\hat{D}ᵢ(\hat{T}ᵢ⁰) on the link affects transportation, which is used for social cost measurement of the transportation. In the social cost measurement, a social cost caused by transportation services, e.g., a social cost caused by the ridesharing path plan 120 and a social cost caused by individual transportations, e.g., a social cost 140 caused by each of the individual path plan 128A and the individual path plan 128B. In some example embodiments, the social cost caused by the ridesharing path plan 120 is measured based on a delay along the ridesharing path plan 120, referred to as a first delay 136. In a similar manner, a combined social cost caused by the individual path plans is measured based on a delay, referred to as a second delay 138 along the individual path plans 128A and 128B.

The measured social cost of the ridesharing path plan 120 may have a positive or a negative impact to the society. To that end, the positive or negative social cost caused by the ridesharing path plan 120 is determined based on a comparison 140 between the first delay 136 and the second delay 138. In the comparison 140, a difference between the first delay and second delay is obtained as a measured social cost 142.

The first delay 136 and the second delay 138 for the social cost measurement are estimated by the system 110. The system 110 is further described with reference to FIG. 1E.

FIG. 1E shows a block diagram of the system 110 for measuring social cost of a ridesharing service, according to some embodiments of the present disclosure. The system 110 includes an input interface 144, a memory 146, an output interface 148 and a processor 150. The input interface 144 is configured to accept pick-up and destination locations for a set of passengers. The set of passengers comprises one or more passengers, such as the passengers 104A and 104B at different pick-up locations, i.e., the pick-up locations 122A and 124A. The input interface 144 also receives information about traffic in a region including the accepted pick-up locations (i.e., the pick-up locations 122A and 124A) and destination locations (i.e., the destination locations 122B and 124B). The input interface 144 further receives a ridesharing path plan (e.g., the ridesharing path plan 120) estimated by the ridesharing service, such as the ridesharing service system 102 for the vehicle 114 to transport the set of passengers 104A and 104B between their corresponding pick-up and destination locations (i.e., the location 122A to the location 122B and the location 124A to the location 124B).

The memory 146 is configured to store instructions to be executed by the processor 150. In some embodiments, the processor 150 is configured to estimate a first delay in traffic that may be caused by the vehicle 114 traveling along the ridesharing path plan estimated by the ridesharing service system 102 to transport the set of passengers. The processor 150 is also configured to simulate an individual transportation of each of the set of passengers between their corresponding pickup and destination locations. The simulated individual transportation is used to estimate a second delay in the traffic that may be caused by a combination of the individual transportation of each of the set of passengers. Each of the individual path plans corresponds to each of the pickup and destination locations of each of the set of passengers. The processor 150 is further configured to determine the social cost of the ridesharing service based on a difference between the first delay and the second delay. The determined social cost of the ridesharing service is provided as an output, via the output interface 148.

In some embodiments, the processor 150 may be configured to estimate an individual path plan forming a shortest route connecting their corresponding pick-up and destination locations (e.g. the locations 122A to locations 122B and locations 124A to locations 124B). For instance, the shortest path may be estimated based on shortest path problem technique. The shortest path problem is a problem of finding a path between two vertices (or nodes) in a graph such that a sum of weights of its constituent edges is minimized. The problem of finding the shortest path between two intersections on a road map may be modeled as a special case of the shortest path problem in graphs, where the vertices correspond to intersections and the edges correspond to road segments, each weighted by the length of the segment. Examples of algorithms to find the shortest path include, but not limited to, Dijkstra's algorithm, Bellman-Ford algorithm, A* search algorithm, Floyd-Warshall algorithm, Johnson's algorithm, Viterbi algorithm. In some other embodiments, the processor 150 may be configured to estimate an individual path plan forming a fastest route connecting their corresponding pick-up and destination locations (e.g. the locations 122A to locations 122B and locations 124A to locations 124B).

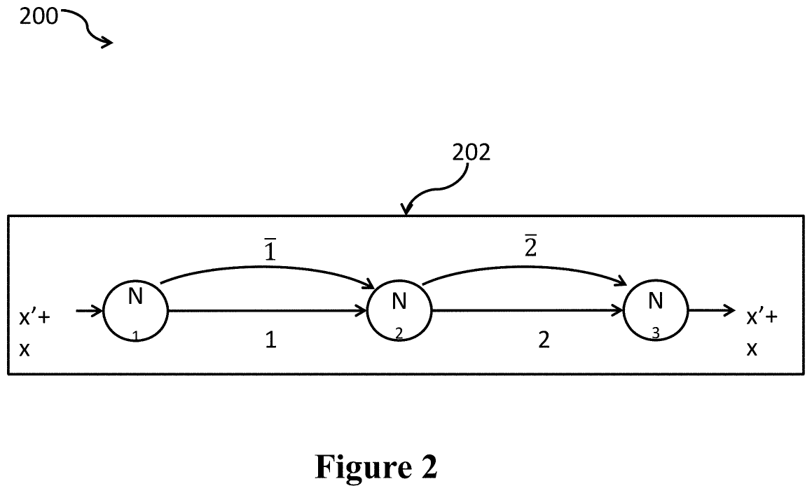

The measurement of social cost of the ridesharing service is further described with reference to FIG. 2.

FIG. 2 shows a representation 200 depicting measurement of the social cost of the ridesharing service, according to some example embodiments of the present disclosure. In some embodiments, the simulation of individual transportation of each of the passengers, such as the passengers 104A and 104B, the processor 150 is configured to simulate weighted distribution of vehicles of the individual transportation of each of the passengers 104A and 104B. In some embodiments, a static behavior of traffic may be modeled as a static game on a traffic network 202. To that end, concept of Nash equilibrium may be implemented for a static traffic on the traffic network 202. In some example embodiments, the ridesharing services may provide positive effect in the transportation service. The positive effect of the ridesharing services may be quantified by solving an optimization problem using the Nash equilibrium. The optimization problem may be represented as,

minₓΣ_{i∈ε}∫₀^{x}^{ᵢ}dᵢ(s)ds, (1a)

sub. to Ax=b, (1b)

0≤x≤x̅ (1c)

Here, dᵢ is a delay function on each link (i) of a path plan (i.e., the ridesharing path plan 120 or the individual path plans 128A and 128B); E is a set of directed links or edges; let x: ϵ→R₊ be a vector representing flow on each link; a matrix A: G→{0, ±1} represents a graph topology and satisfies,

Aᵢⱼ=I_{j=σ(i)}−Iⱼ₌ᵣ₍ᵢ₎ (2)

Further, b is a vector such that b: V→R₊ represents exogenous flows into or out of each node. The exogenous flows are inflow rates of the traffic network 202 that are balance so that Σ_{j∈V}bⱼ=0 and x̅ is a vector. Here, x̅:ε→R represents capacity limit on each link and is strictly positive. A total delay is termed as the social cost, which is given by the following expression:

Σ_{i∈ε}xᵢdᵢ(xᵢ) (3)

To that end, the traffic network 202 be modeled as a directed graph, G=V×E. Here, V is a set of nodes or vertexes (such as N₁, N₂ and N₃) and E is a set of directed links or edges (such as link 1, link 2, link 1̅ and link 2̅). The nodes N₁, N₂ and N₃ may represent the locations 122A, 122B and 124A and 124B. The links 1, 2, 1̅ and 2̅ may represent path plans connecting the locations 122A, 122B and 124A and 124B. In each of the links 1, 2, 1̅ and 2̅, flow of traffic may be indicated by a vector x: E→R₊ and delay in traffic may be a delay function vector d: E→(R₊→R₊). For instance, the first delay may correspond to the ridesharing path plan 120 and the second delay may correspond to a combination of the individual path plans 128A and 128B.

Each delay function dᵢ: R₊→R₊ is a piecewise-continuous, positive and non-decreasing function, dᵢ(ξ+η)≥dᵢ(ξ)>0, ∀i∈ε, ∀ξ, η∈R₊.

The optimization problem at equation (1) may provide a solution for an expected distribution x of flow at the Nash equilibrium and may measure the social cost using equation (3), in absence of ridesharing and relating the actual cost in absence of ridesharing. To that end, a minimizer for equation (1) may be represented by x*: E→R and x^{R} may represent an actual vector of flows. The actual flow x may consist of individual vehicles, such as the vehicle 114 and the vehicle 130.

In some example embodiments, each of the vehicles 114 and 130 may have more or less than one passenger. To that end, a weighted distribution of vehicles 114 and 130 of individual transportation of each of the set of passengers 104A and 104B may be simulated by the processor 150 of the system 110. For instance, let flow of x^{R,n}, n=0, 1, 2, . . . , be distribution of routes of a ridesharing vehicle, such as the vehicle 114 carrying n passengers so that Σₙ₌₀^{∞}=x^{R}. A weighted distribution of the vehicles 114 and 130 is given by

\tilde{x}^{R}:=Σₙ₌₀^{∞}nx^{R,n} (4)

In some embodiments, a difference between social cost of flow x* at the Nash equilibrium and social cost of actual flow x,

ΔS:=Σᵢ\tilde{x}ᵢ^{R}d(xᵢ^{R})−x*ᵢdᵢ(x*ᵢ) (5)

Here, ΔS is based on social cost over each of the passengers 104A and 104B, an aggregate of which is represented by the weighted distribution \tilde{x}^{R}, whose delay is based on actual distribution of flow x^{R}. A negative additional cost ΔS implies a net improvement of social cost with use of the ridesharing services of the ridesharing service system 102.

In some example embodiments, the social cost may be negative, i.e., ΔS≤0. To that end, delay at link 2̅ (d_{2̅}) may more than delay at link 2 (d₂). Let, d_{2̅}>d₂(0) and vehicles, such as the vehicle 114 services a flow x with exactly one passenger, such as the passenger 104A or the passenger 104B. At Nash equilibrium, the vehicles utilize link 1 until delay dᵢ (xᵢ)>d_{1̅}. Link 2 may be under saturated at full flow, i.e. d₂ (x)<d_{2̅}, the flow at the user equilibrium is given by x*₁=0, x*_{1̅}=x, x*₂=x and x*₂=0. The social cost is given by, xd_{1̅}+xd₂(x). Let flow x^{R} be actual flow in the traffic network 202 and \tilde{x}^{R} be the weighted flow. The additional social cost is given by,

\tilde{x}₁^{R}d(x₁^{R})+(x−\tilde{x}₁^{R})d_{1̅}+\tilde{x}₂^{R}d(\tilde{x}₂^{R})+(x−\tilde{x}₂^{R})d_{2̅}−xd_{1̅}−xd₂(x)=\tilde{x}₁^{R}(d(x₁^{R})−d_{1̅})−\tilde{x}₂^{R}(d_{2̅}−d(x₂^{R}))+x(d_{2̅}−d₂(x)). (6)

If x₂^{R}=x, as at the user equilibrium, then the constraint ΔS≤0 requires that, \tilde{x}₁^{R} (d(x₁^{R})−d_{1̅})≤0, which implies that x₁^{R}=0. In order to provide the transportation service on link 1, the ridesharing service system 102 may make a tradeoff by decreasing in proportional amount of transportation service on link 2 and introduce a ridesharing service, such as carpooling that satisfies, \tilde{x}₂^{R}(d_{2̅}−d₂(x₂^{R}))−\tilde{x}₁^{R}d((x₁^{R})−d_{1̅})≥x(d_{2̅}−d₂(x)). This may encourage the ridesharing service system 102 to suspend transportation services of some vehicles on the traffic network 202. The suspension of the transportation services may reduce impact on negative externalities of the ridesharing services.

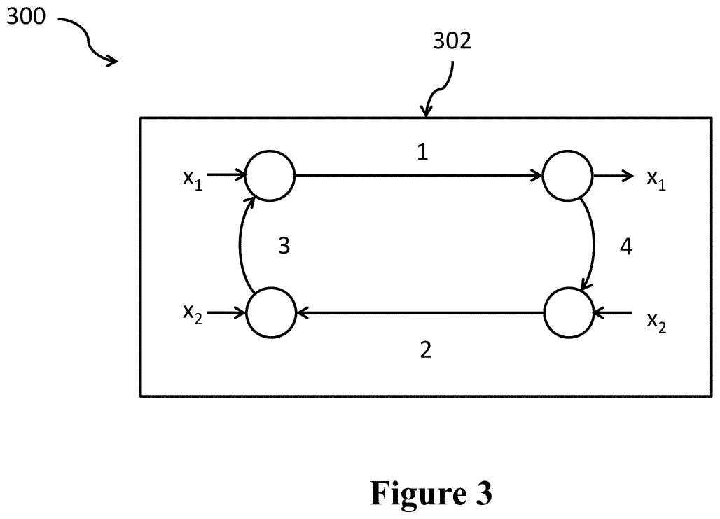

There maybe different scenarios that the social costs may differ, which is described next with reference to FIG. 3.

FIG. 3 shows a representation 300 depicting measurement of the social cost of the ridesharing service, according to some other example embodiments of the present disclosure. The representation 300 includes a traffic network 302 with links 1, 2, 3 and 4. In the traffic network 302, each of the links 1, 2, 3 and 4 may have a flow x, such that x₁>x₂>x_{1/2}. The delays may be equal in the links 1, 2, 3 and 4. In first scenario, there may no ridesharing service available in the links 1, 2, 3 and 4. In such scenario, the flow may be at user equilibrium, i.e., x₁^{R}=x₁, x₂^{R}=x₂, x₃^{R}=x₄^{R}=0, and \tilde{x}^{R}=x^{R}. In second scenario, the flows along edges of the link 1 of the traffic network 302 may be x₁ as x₁ vehicles are to return to pick up passengers, while satisfying transportation service request of the set of passengers such as the passengers 104A and 104B. When the flows are at x₁>x₂, the vehicles (e.g., the vehicles 114 and 130) may satisfy the transportation service request of the flow if x₂^{R}=x₁; the weighted flows are \tilde{x}₁^{R}=\tilde{x}₂^{R}=x₁ and \tilde{x}₃^{R}=\tilde{x}₄^{R}=0. In third scenario, the flow along the edges of the traffic network 302 may be x_{1/2} when each of the vehicles 114 and 130 carries two passengers and the weighted flows are \tilde{x}₁^{R}=\tilde{x}₂^{R}=x₁ and \tilde{x}₃^{R}=\tilde{x}₄^{R}=0. In the second scenario, ridesharing results in an in social cost as the vehicles may be traveling without any passengers until the pick-up location of corresponding passengers is reached. The increment in the social cost may be given by,

Σᵢ₌₁⁴\tilde{x}ᵢ^{R}dᵢ(xᵢ^{R})x*ᵢdᵢ(xᵢ)=x₂(d₂(x₁)−d₂(x₂))>0 (7)

In the third scenario, ridesharing results in a decrease in social cost,

$${x}_{1} ( {d}_{1} ( \frac{{x}_{1}}{2} ) - {d}_{1} ( {x}_{1} ) ) + {x}_{2} ( {d}_{2} ( \frac{{x}_{1}}{2} ) - {d}_{2} ( {x}_{2} ) ) < 0.$$

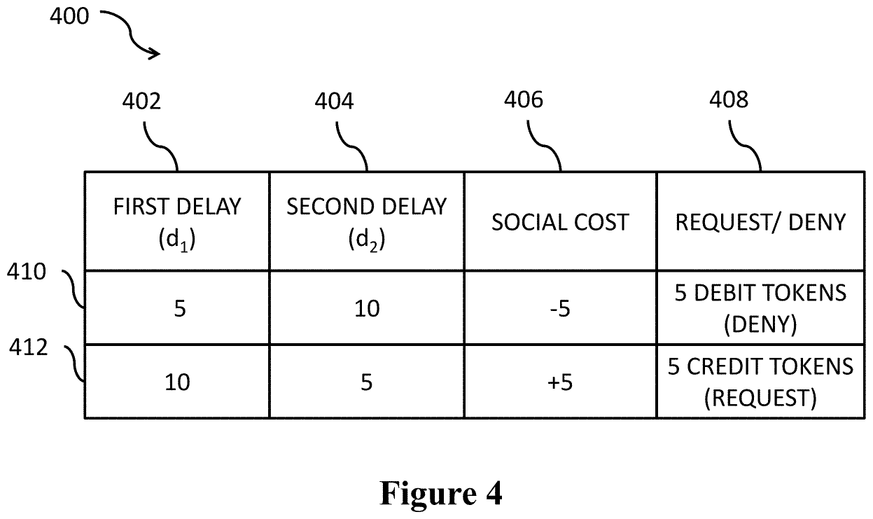

The difference in delays (e.g., first delay and second delay) in ridesharing path plan 120 and a combination of the individual path plans 128A and 128B, contribute in measurement of the social cost of the ridesharing, which is shown in FIG. 4.

FIG. 4 shows a tabular representation 400 depicting a social cost of the ridesharing service, according to some example embodiments of the present disclosure. The tabular representation 400 includes column fields, first delay (d₁) 402, second delay (d₂) 404, social cost 406 and request/deny option 408. In row 410, the first delay under the column field 402 is 5 and the second delay under the column field 404 is 10. The difference between the first delay and second delay is a negative value, i.e., −5. This implies ΔS<0 and the first delay at the ridesharing path plan 120 may more than the second delay at the individual path plans 128A and 128B. In row 412, the first delay under the column field 402 is 10 and the second delay under the column field 404 is 5. The difference between the first delay and second delay is a positive value, i.e., 5, which indicates that the ridesharing service system 102 may allow the ridesharing service by the vehicle 114 along the ridesharing path plan 120.

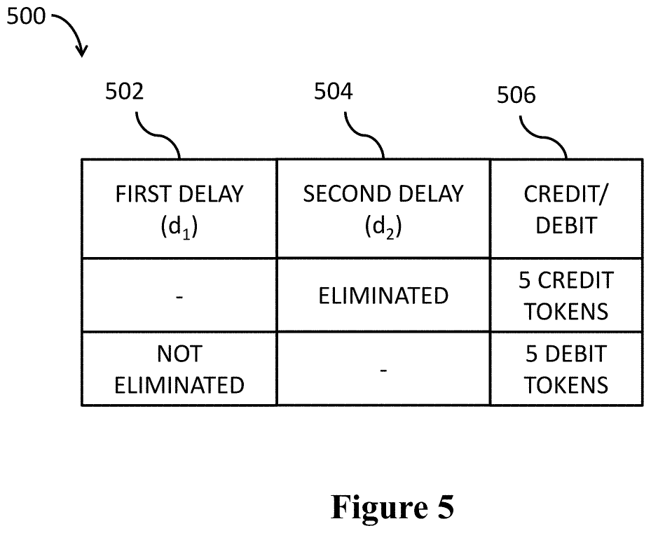

In some embodiments, when there is cause of the first delay or elimination of the second delay, the ridesharing service system 102 may get debited or credited, which is shown in FIG. 5.

FIG. 5 shows a tabular representation 500 depicting credit or debit for the ridesharing service, according to some example embodiments of the present disclosure. The tabular representation 500 includes column fields, first delay (d₁) 502, second delay (d₂) 504 and credit/debit option 506. When there is elimination of the second delay, ridesharing service system 102 receives credits, e.g. 5 credit tokens. When there is increase in the first delay, the ridesharing service system 102 may receive debits, e.g. 5 debit tokens. These credits and debits are determined by the system 110.

In some embodiments, the credits and debits may be exchanged among multiple ridesharing service providers. The ridesharing service providers may be controlled by the ridesharing service system 102. A credit for a ridesharing service is determined by the system 110 after completion of a transportation service of the passenger 104A. The credit may be equal to sum of delay of the passenger 104A and amount of delay caused by other passengers, such as the passenger 104B. The credit is determined by,

C⁽ⁱ⁾:=\hat{T}ᵢ¹−\hat{T}ᵢ⁰+\hat{X}ᵢ(\hat{T}ᵢ¹)(Dᵢ(\hat{X}ᵢ(\hat{T}ᵢ¹))−Dᵢ(\hat{X}ᵢ(\hat{T}ᵢ¹)−1)) (8)

Here, \hat{T}ᵢ¹ is at exit and is equal to time at entry \hat{T}ᵢ⁰ plus the delay at that time, which is deterministic and given by,

\hat{T}ᵢ¹−\hat{T}ᵢ⁰=Dᵢ(\hat{X}ᵢ(\hat{T}ᵢ⁰)) (9)

Using, equation (13) to replace \hat{T}ᵢ¹ in equation (12). The total credited for virtual path plan p* is given by,

$${\sum }_{i ∈ {p}^{*}} {C}^{( i )}$$

The debits for the ridesharing service providers may be determined in real-time. A debit for each link is earned after a passenger exits a link is equal to sum of the passenger's own delay and amount of delay caused by other passengers,

B⁽ⁱ⁾:=nᵢ(\hat{T}ᵢ¹−\hat{T}ᵢ⁰)+Xᵢ(\hat{T}ᵢ¹)(Dᵢ(Xᵢ(Tᵢ¹))−Dᵢ(Xᵢ(\hat{T}ᵢ¹)−1)) (10)

Here, nᵢ is number of passengers in the vehicle of link i. The total debited for a path plan p is given by,

$${\sum }_{i ∈ p} {B}^{( i )}$$

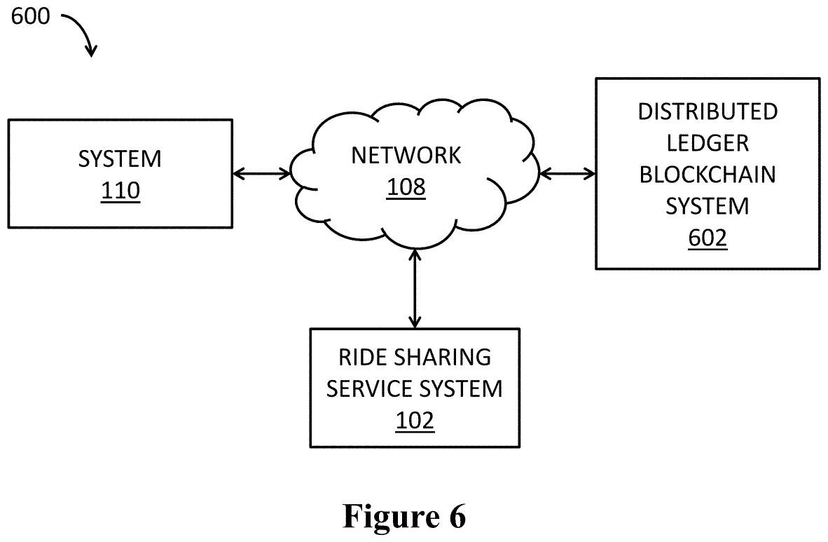

The system 110 may share the debits and credits for the ridesharing services to the ridesharing service system 102. In some example embodiments, the debits or credits may correspond to points, such as loyalty points, coin-based debit/credit, or the like. Additionally, or alternatively, the debits and credits may be issued based on a blockchain technology, which is described next with reference to FIG. 6.

FIG. 6 shows a representation 600 depicting credit/debit transaction for ridesharing by a distributed ledger blockchain system, according to some example embodiments of the present disclosure. There is shown the system 110, the ridesharing service system 102 and a distributed ledger blockchain system 602. In some embodiments, the social cost measured by the system 110 may be capped on ridesharing transportation services of the ridesharing service system 102. In an example embodiment, a cap on the ridesharing services may be set as a sum of social costs measured in a simulated environment. The ridesharing service system 102 may ensure that an aggregated social effect of their activity is below the sum of social effect of activity according to the simulated environment.

In a static traffic, a marginal cost of a path plan p*in the simulated environment may be given by,

Σ_{iϵp*}dᵢ(x*ᵢ)+x*ᵢd′ᵢ(x*ᵢ) (11)

where, x*ᵢ is the solution to (1) and d′ᵢ is the right-hand derivative satisfying,

$${d}_{i}^{′} ( x ) = {lim}_{ɛ -> {0}^{+}} \frac{{d}_{i} ( x + ɛ ) - {d}_{i} ( x )}{ɛ} \qquad ( 12 )$$

The cost to the provider is determined as the social cost of actual routes. For a single route, the social cost is given by,

Σ_{i∈p}nᵢdᵢ(xᵢ^{R})+\tilde{x}ᵢ^{R}d′ᵢ(xᵢ^{R}) (13)

where, nᵢ is the number of passengers in the vehicle at link i. For example, the number of passengers may be 2 for the vehicle 114 at a single path plan 120.

In case of static distribution of ridesharing path plans, flows of the vehicles 114 and 130 and a weighted distribution are at x^{R} and \tilde{x}^{R}. The cost to be debited from the ridesharing service system 102 is given by,

B*:=Σ_{i∈ε}\tilde{x}ᵢ^{R}dᵢ(xᵢ^{R}) (14)

The cost to be credited to the ridesharing service system 102 is given by,

C*:=Σ_{i∈ε}xᵢ^{R}dᵢ(\tilde{x}*ᵢ) (15)

Here, x*ᵢ is the flow of vehicles (such as the vehicle 114) in the ridesharing path plan 120, which is solution to the optimization problem denoted by equation (1).

In one example embodiment, issuance of the credits and debits may be implemented via a clearing house entity (not shown in FIG. 6). The clearing house entity may be connected to the distributed ledger blockchain system 602 via the network 108. The clearing house entity may require repayment of debts issued at the end of each day or every week, to reduce temporal effects of traffic.

In some example embodiments, the distributed ledger blockchain system 602 may implement transactions in distributed ledgers having a blockchain protocol. The blockchain protocol provides a decentralized, distributed, and oftentimes public, digital ledger that is used to record transactions across many computers so that any involved record is not altered retroactively, without the alteration of all subsequent blocks. This allows participants of transactions to verify and audit transactions independently and relatively inexpensively. In some example embodiments, the blockchain protocol may be suitable for creation of both credit and debit transactions. The blockchain protocol may be executed for receiving messages and processing the messages into one or more blocks of a blockchain. These one or more blocks may be connected to a plurality of nodes in the distributed ledger blockchain system 602. A node corresponds to a building block of an entire network using the blockchain protocol. For instance, the node may contain a copy of the entire blockchain. Further, each of the plurality of nodes may be interconnected to every other node in the network. Each node may be embodied in a plurality of ways, including but not limited to such as a computer, a mobile device, a handheld, a portable computing device, a tablet, a smartphone, a laptop, a smart wearable device and the like.

During processing of the messages, the distributed ledger blockchain system 602 may generate different types of the transaction including a credit transaction having an unmatched output configured for matching to the next transaction; a debit transaction having an unmatched input configured for matching to the previous transaction and a transfer transaction having a matched input and a matched output. The transfer transaction can be of different types, such as unspent debt-credit transaction and/or partially-repaid debt transaction, and others. In some implementation, the different types of the transaction can optionally include a coin-base transaction.

In some embodiments, the blockchain protocol may be implemented through use of an unspent transaction model (UTXO) model. To that end, a message may be associated with a transaction to be included in the blockchain by matching inputs and outputs of the transaction to neighboring transactions such that an input of the transaction is matched to an output of a previous transaction and an output of the transaction is matched to an input of a next transaction. In the UTXO model, if notion of credits is structured based on unmatched outputs of the transactions, notion of debits in extended UTXO model may be structured based on transactions with unmatched inputs. In other words, credit is a transaction with inputs and unmatched outputs, debit is a transaction with outputs and unmatched inputs. Such transactions with outputs and unmatched inputs may be referred to as debt transactions. In such a manner, debt transactions can be naturally integrated into the UTXO model. The introduction of debt transaction based on unmatched inputs integrates the debt and credit transaction into a single protocol. In one example embodiment, the distributed ledger blockchain system 602 may include a debt pool for storing a record of all outstanding debt transactions in the debt based distributed ledger blockchain system 602. When a debt is repaid, its corresponding debt transaction is removed from the debt pool and whenever debt is taken, a new transaction is added to the debt pool. The distributed ledger blockchain system 602 may also be configured to store a record of all other transactions, such as credit transactions, debt-credit transactions and the like. The record of the transactions may be stored in one or more databases, such as a block database (not shown in FIG. 6).

The one or more blockchain databases may be managed autonomously using a peer-to-peer network of the plurality of nodes and a distributed timestamping server. They are authenticated by mass collaboration powered by collective self-interests. Such a design facilitates robust workflow where uncertainty of the participants regarding data security is marginal. The use of a blockchain removes the characteristic of infinite reproducibility from a digital asset. It confirms that each unit of value was transferred only once, solving the long-standing problem of double spending. In some example embodiments, the one or more blockchain databases may be based on database architectures such as a relational database architecture that may store information for the ridesharing service system 102, external regulatory and compliance related information, third party resources, and the like. The distributed ledger blockchain system 602 may be communicatively coupled to the system 110 and the ridesharing service system 102 through the network 108.

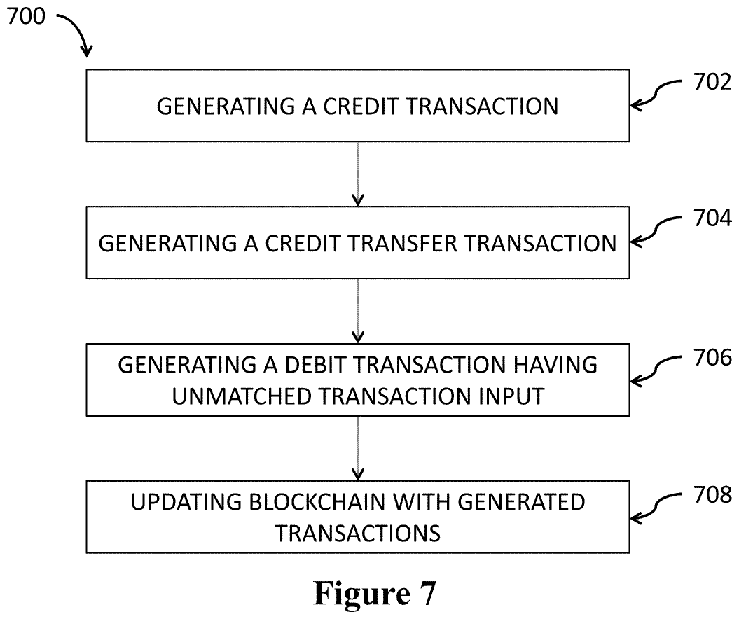

FIG. 7 shows a method flow diagram 700 for credit/debit transactions by the distributed ledger blockchain system 602, according to some example embodiments of the present disclosure. The method 700 is performed by the distributed ledger blockchain system 602 upon receiving credits and debits for the ridesharing services from the system 110.

At step 702, a credit transaction is generated. The credit transaction may have both an input and an output. The input may point to a sender of credit and the output may point to a recipient of the credit. For instance, the sender or recipient may be between ridesharing service providers, between a bank and a ridesharing service provider, etc.

At step 704, a credit transfer transaction is generated. The credit transaction may be a transaction involving at least two nodes, e.g., first ridesharing service provider and second ridesharing service provider. The credit transaction may be transferred by mentioning an address of the first ridesharing service provider in an input field of the transaction received at the second ridesharing service provider and an address of the second ridesharing service provider in an output field of corresponding debit transaction originating at the first ridesharing service provider. In some cases, the credit transfer transaction may be generated when the first ridesharing service provider does not have sufficient credit or spendable UTXO amount available and thus, needs to take a debt for performing this credit transfer.

At step 706, a debit transaction is generated. The debit transaction may be generated when there is an unmatched transaction or no parent transaction as input. For instance, when the first ridesharing service provider needs debt, the output of the debit transaction points to the first ridesharing service provider. At the same time, the generated debt transaction may be added to a debt pool.

At step 708, a blockchain in the distributed ledger blockchain system 602 is updated with the generated transactions. Additionally, or alternatively, the distributed ledger blockchain system 602 may also include exchanging various messages describing a sequence of events associated with coin-base transactions.

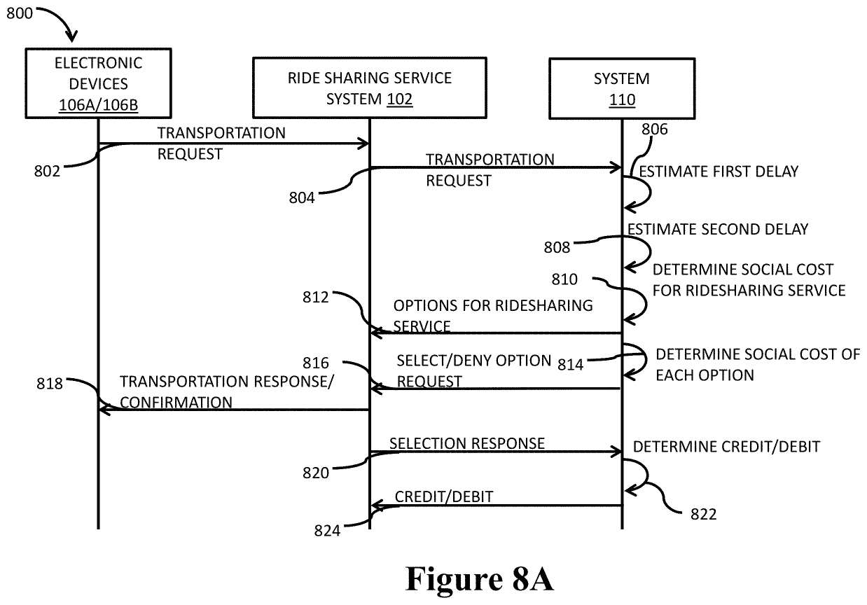

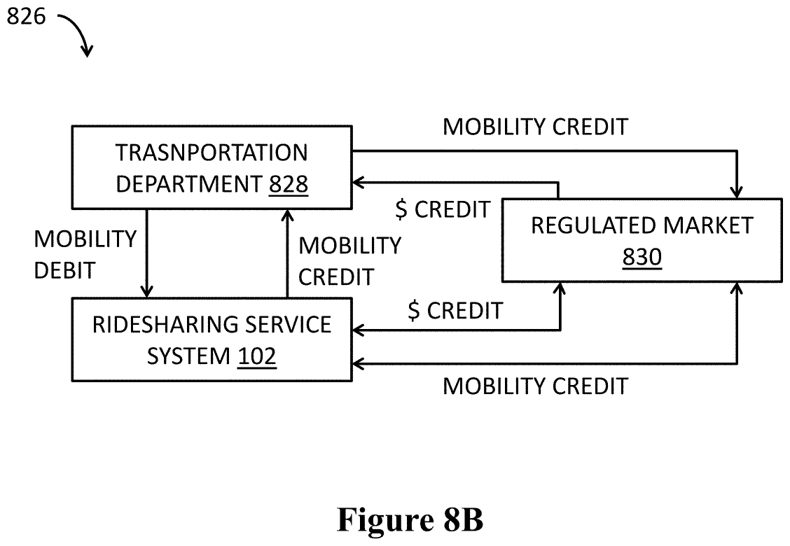

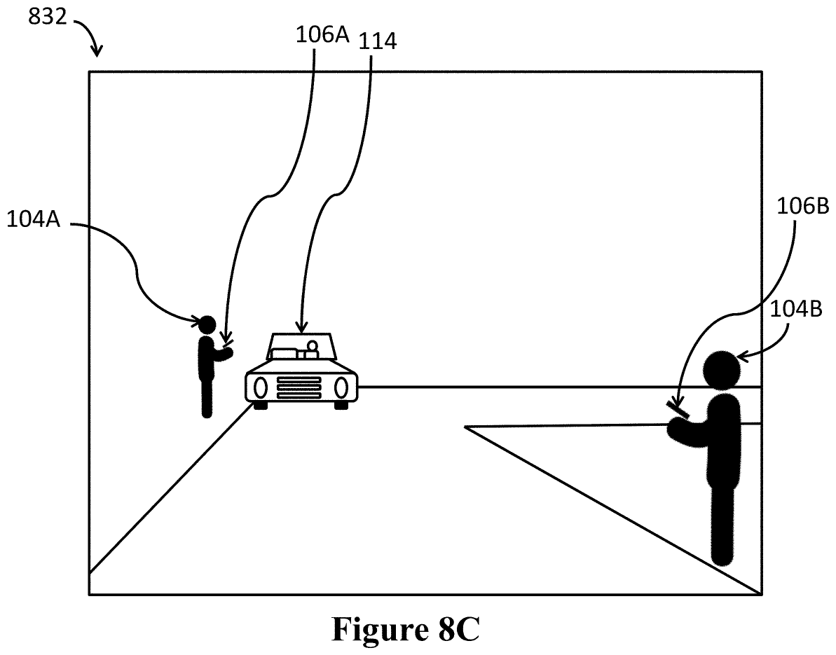

FIG. 8A shows a sequence flow diagram 800 depicting implementation of the system 110, according to some example embodiments of the present disclosure. In an example embodiment, a set of passengers, e.g., the passengers 104A and 104B requests for transportation to the ridesharing service system 102, using their corresponding electronic devices 106A and 106B. At step 802, the electronic device 106A/106B sends a transportation request to the ridesharing service system 102 from the electronic device 106A/106B. The transportation request includes a pick-up and destination locations of the corresponding passenger 104A or 104B. The ridesharing service system 102 determines a ridesharing path plan based on the pick-up and destination locations. At step 804, the ridesharing service system 102 sends the pick-up and destination locations along with the ridesharing path plan to the system 110.

At step 806, the system 110 estimates a first delay in traffic along the ridesharing path plan. The first delay is estimated based on the pick-up and destination locations as well as traffic information from the traffic control system 112.

At step 808, the system 110 estimates a second delay in the traffic caused by a combination of individual transportation path plans of each of the passengers 104A and 104B. The second delay is estimated in a simulation, where an individual transportation path plan for each of the set of passengers between their corresponding pick-up and destination locations is simulated.

At step 810, a social cost for a ridesharing service between the passengers 104A and 104B is determined. The social cost is determined based on a difference between the first delay and the second delay in the traffic. In case, the social cost is negative, the ridesharing service system 102 may proceed with the ridesharing service. In other case, the social cost may be positive based on the difference. In such a case, the ridesharing service system 102 may suspend the ridesharing service and proceed with the individual path plans for the transportation of the passengers 104A and 104B.

At step 812, the ridesharing service system 102 shares multiple options for ridesharing path plan for servicing the passengers 104A and 1104B to the system 110. At step 814, the system 110 estimates social cost of each of the multiple options, upon receipt of the multiple options. At step 816, the system 110 sends a request to the ridesharing service system 102 to select an option from the multiple options corresponding to lowest social cost or deny ridesharing requests having negative social cost.

At step 818, the ridesharing service system 110 sends the response of the selected option for the ridesharing to the electronic device 106A/106B. At step 820, the ridesharing service system 102 sends a response or confirmation for transportation of the passengers 104A and 104B based on the selected response from the multiple options.

At step 822, the system 110 determines credits or debits for the ridesharing. In some embodiments, the credits may be determined upon elimination of the second delay. The debits may be determined when there is cause of the first delay due to the ridesharing. The system 110 may issue the credits in proportion to the social cost of the ridesharing service when the social cost is negative. The debts may be issued in proportion to the social cost of the ridesharing service when the social cost is positive. At step 824, these credits or debits are assigned to the ridesharing service system 102 for the ridesharing service. In some example embodiments, the credits or debits may be issued using the distributed ledger blockchain system 602. These credits/debits may be exchanged via a clearing housing entity with the distributed ledger blockchain system 602. The exchange of the credits/debits is described next with reference to FIG. 8B.

FIG. 8B illustrates a representation 826 depicting an exchange of credits/debits by a ridesharing service of the ridesharing service system 102, according to some example embodiments of the present disclosure. The ridesharing service system 102 may exchange the credits/debits (e.g., mobility credits/mobility debits) with a mobility bank, e.g., a transportation department 828. The mobility credits/mobility debits may be exchanged between the ridesharing service system 102 and the transportation department 828, via a clearing house entity, e.g., a regulated market 830. For instance, the transportation department 828 may issue debits to the ridesharing service system 102 and issue credits on the regulated market 830. The ridesharing service system 102 may trade excess credits with the regulated market 830. Additionally, or alternatively, the ridesharing service system 102 may incentivized for efficiently providing socially benefit mobility service.

FIG. 8C illustrates a use case scenario 832 for ridesharing, according to one example embodiment of the present disclosure. When the ridesharing service system 102 selects an option based on selection of the lowest social cost, the passengers 104A and 104B may share the vehicle 114 along the ridesharing path plan 120. In another scenario, the ridesharing service system 102 may suspend the ridesharing path plan 120 and provide individual transportation of the passengers 104A and 104B, which is shown in FIG. 8C. In use case the scenario 832, the ridesharing service system 102 may assign the vehicle 114 to the passenger 104A along the individual path plan 128A and assign another vehicle, e.g., the vehicle 130 to the passenger 104B along the individual path plan 128B, which is shown in FIG. 1C. Each of the individual path plans 128A and 128B may be fastest or shortest route.

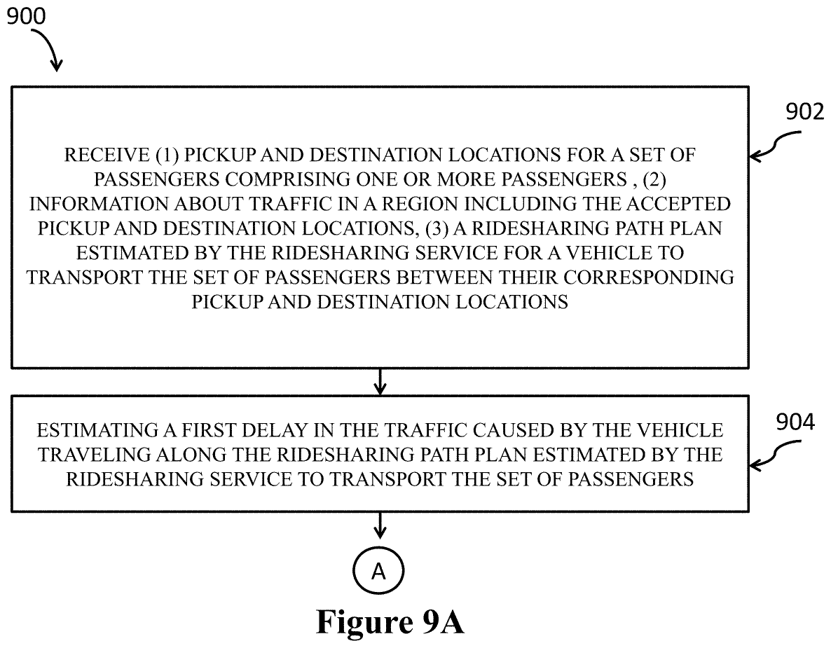

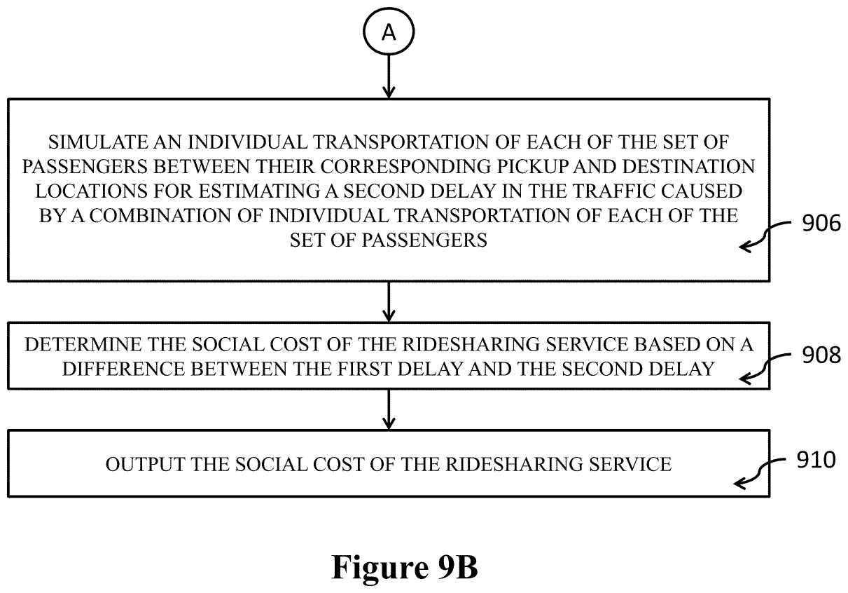

FIGS. 9A and 9B shows a method flow 900 for measuring social cost of a ridesharing service by the system 110, according to some other example embodiments of the present disclosure. The method flow 900 includes operations 902-910, that are performed by the system 110. At operation 902, pickup and destination locations (e.g., the pick-up locations 122A and 124A and the destination locations 122B and 124B) for a set of passengers (e.g., the passengers 104A and 104B) are accepted along with information about traffic in a region including the accepted pickup and destination locations and a ridesharing path plan estimated by a ridesharing service for a vehicle (e.g., the vehicle 114) to transport the set of passengers between their corresponding pick-up and destination locations. The passengers 104A or 104B may request for the transportation from the ridesharing service system 102 using their corresponding electronic devices 106A and 106B.

At operation 904, a first delay in the traffic caused by the vehicle traveling along the ridesharing path plan, is estimated. In some example embodiments, the first delay is determined based on the pick-up and destination locations, traffic information along the ridesharing path plan and the ridesharing path plan shared by the ridesharing service (e.g., the ridesharing service system 102). At operation 906, an individual transportation path plan for each of the set of passengers between their corresponding pickup and destination locations is simulated for estimating a second delay in the traffic caused by a combination of individual transportation path plan of each of the passengers 104A and 104B. In some embodiments, the second delay may correspond to delay functions indicative of delays on the individual path plans 128A and 128B.

At operation 908, the social cost of the ridesharing service is determined based on a difference between the first delay and the second delay. In some example embodiment, the first delay and second delay may correspond to time delay in their corresponding path plans. For instance, the first delay may be a delay of 5 seconds and the second delay may be a delay of 10 seconds. The difference between the first and second delays corresponds to the social cost. At operation 910, the social cost of the ridesharing service is outputted via the output interface 148 of the system 110.

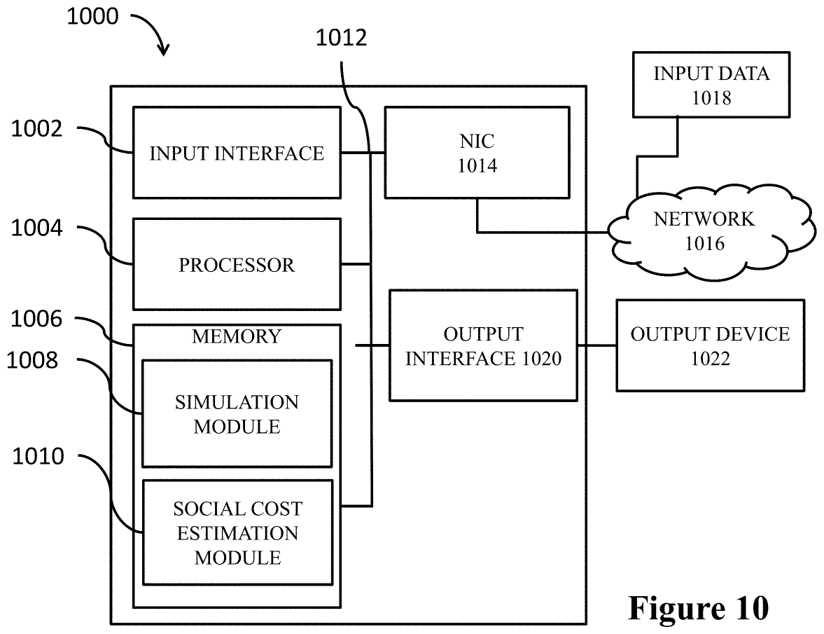

FIG. 10 shows an overall block diagram of a system 1000, according to some example embodiments of the present disclosure. The system 1000 corresponds to the system 110 of FIG. 1. The system 1000 includes an input interface 1002, a processor 1004, a memory 1006, a network interface controller 1014, and an output interface 1020. The input interface 1002 is configured to accept the pickup and destination locations for the set of passengers, information about traffic in a region including the accepted pickup and destination locations, a ridesharing path plan estimated by the ridesharing service for a vehicle to transport the set of passengers between their corresponding pick-up and destination locations. The processor 1004 is configured to execute instructions stored in the memory 1006. Additionally, or alternatively, the memory 1006 may be configured to store modules, such as a simulation module 1008 and a social cost estimation module 1010. The modules may be executed by the processor 1010 for measurement of the social cost of the ridesharing service to transport the set of passengers. The simulation module 1008 may be configured to estimate a first delay in the traffic caused by the vehicle traveling along the ridesharing path plan estimated by the ridesharing service to transport the set of passengers. Further, the simulation module 1008 may be configured to simulate an individual transportation path plan for each of the set of passengers between their corresponding pick-up and destination locations to estimate a second delay in the traffic caused by a combination of the individual transportation path plan of each of the set of passengers based on the simulation. The social cost estimation module 1010 may be configured to determine the social cost of the ridesharing service based on a difference between the first delay and the second delay.

The processor 1004 corresponds to the processor 150. The processor 1004 may be a single core processor, a multi-core processor, a computing cluster, or any number of other configurations. The memory 1006 may include random access memory (RAM), read only memory (ROM), flash memory, or any other suitable memory systems. The processor 804 is connected through a bus 1012 to the input interface 1002. These instructions implement a method 900 for measuring the social cost of a ridesharing service to transport a set of passengers requesting transportation from their corresponding pick-up to destination locations.

In some implementations, the system 1000 may have different types and combination of input interfaces to receive input data 1018 that may include the pickup and destination locations, the traffic information and the ridesharing path plan from the ridesharing service system 102. In one implementation, the input interface 1002 may include a keyboard and/or pointing device, such as a mouse, trackball, touchpad, joy stick, pointing stick, stylus, or touchscreen, among others.

Additionally, or alternatively, the network interface controller 1014 may be adapted to connect the system 1000 through the bus 1012 to a network 1016. Through the network 1016, the input data 1018 may be downloaded and stored within the memory 1006 for storage and/or further processing.

In addition to input interface 1002, the system 1000 may include one or multiple output interfaces to output the determined social cost of the ridesharing. For example, the system 1000 may be linked through the bus 1012 to the output interface 1020 adapted to connect the system 1000 to an output device 1022, wherein the output device 1022 may include a computer monitor, projector, a display device, a screen, mobile device.

In this manner, the system 1000 measures the social cost of ridesharing services. The social cost may be used for limiting or allowing the ridesharing services and prevent negative externalities to society. Additionally, or alternatively, the limitation or allowance may be efficient for improving or controlling traffic on roads.

The above-described embodiments of the present disclosure may be implemented in any of numerous ways. For example, the embodiments may be implemented using hardware, software or a combination thereof. When implemented in software, the software code may be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Also, the embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Therefore, it is the object of the appended claims to cover all such variations and modifications as come within the true spirit and scope of the present disclosure.

1. A computer-implemented system for measuring a social cost of a ridesharing service to transport a set of passengers requesting transportation from their corresponding pick-up to destination locations, the system is operatively connected to a ridesharing service system and a traffic control system over a communication channel to estimate the social cost by executing a computer-implemented simulation of traffic affected by the ridesharing service, wherein the communication channel includes one or a combination of a wired communication channel, a wireless communication channel, or both, the system comprising:
an input interface configured to accept using the communication channel each of:
the pickup and destination locations for the set of passengers including at least two passengers with different one or a combination of the pickup and destination locations,
information about traffic in a region including the accepted pickup and destination locations, wherein the traffic is formed by movements of different vehicles within the region, and
a ridesharing path plan estimated by the ridesharing service for a vehicle to transport the set of passengers between their corresponding pick-up and destination locations;
a processor configured to:
estimate a first delay in the traffic caused by the vehicle traveling along the ridesharing path plan estimated by the ridesharing service to transport the set of passengers;
simulate, using the computer-implemented simulation of the traffic, an individual transportation path plan for each of the set of passengers between their corresponding pick-up and destination locations to estimate a second delay in the traffic caused by a combination of the individual transportation path plan of each of the set of passengers based on the simulation; and
determine the social cost of the ridesharing service based on a difference between the first delay and the second delay; and
an output interface configured to output the social cost of the ridesharing service using the communication channel.

2. The system of claim 1, wherein the processor is further configured to estimate an individual path plan forming a shortest route connecting their corresponding pick-up and destination locations.

3. The system of claim 1, wherein the processor is further configured to estimate an individual path plan forming a fastest route connecting their corresponding pick-up and destination locations.

4. The system of claim 1, wherein the processor is further configured to determine a delay function for the individual path plan of each of the set of passengers.

5. The system of claim 4, wherein the processor is further configured to simulate a weighted distribution of the vehicle of the individual transportation path plan of each of the set of passengers.

6. The system of claim 1, wherein the processor is further configured to:
receive multiple options for the ridesharing path plan for servicing the passengers from the ridesharing service;
estimate the social cost of each of the multiple options, upon receipt of the multiple options; and
send a request to the ridesharing service to select an option from the multiple options corresponding to lowest social cost.

7. The system of claim 1, wherein the processor is further configured to send a request to the ridesharing service to deny ridesharing requests having negative social costs.

8. The system of claim 7, wherein the processor is further configured to:
issue credits in proportion to the social cost of the ridesharing service when the social cost is negative;
issue debits in proportion to the social cost of the ridesharing service when the social cost is positive; and
assign the credits or the debits to the ridesharing service.

9. The system of claim 8, wherein the processor is further configured to issue the credits or the debits using blockchain technology.

10. The system of claim 9, wherein the blockchain technology corresponds to a distributed ledger blockchain.

11. The system of claim 1, wherein the processor is further configured to determine credits for the ridesharing service for eliminating the second delay in the traffic and determine debits for the ridesharing service for causing the first delay in the traffic, such that the social cost defines a difference between the credits and debits of the ridesharing service.

12. A method for measuring a social cost of a ridesharing service to transport a set of passengers requesting transportation from their corresponding pickup to destination locations, the method uses a processor coupled with stored instructions implementing the method, wherein the instructions, when executed by the processor carry out steps of the method, comprising:
accepting, using a wired or wireless communication channel operatively connecting the processor to a ridesharing service system and a traffic control system, each of:
the pickup and destination locations for the set of passengers in the plurality of passengers including at least two passengers with different one or a combination of the pickup and destination locations,
information about traffic in a region including the accepted pickup and destination locations, wherein the traffic is formed by movements of different vehicles within the region, and
a ridesharing path plan estimated by the ridesharing service for a vehicle to transport the set of passengers between their corresponding pickup and destination locations;
estimating a first delay in the traffic caused by the vehicle traveling along the ridesharing path plan estimated by the ridesharing service to transport the set of passengers;
simulating, by executing a computer-implemented simulation of traffic affected by the ridesharing service, an individual transportation path plan for each of the set of passengers between their corresponding pickup and destination locations for estimating a second delay in the traffic caused by a combination of individual transportation path plans of the passengers;
determining the social cost of the ridesharing service based on a difference between the first delay and the second delay; and
outputting the social cost of the ridesharing service.

13. The method of claim 12, further comprising estimating the individual path plan of each of the set of passengers forming a shortest route connecting their corresponding pick-up and destination locations.

14. The method of claim 12, further comprising: estimating the individual path plan of each of the set of passengers forming a fastest route connecting their corresponding pickup and destination locations.

15. The method of claim 12, further comprising: determining a delay function for the individual path plan of each of the set of passengers.

16. The method of claim 15, further comprising simulating a weighted distribution of the vehicles of the individual transportation of each of the set of passengers.

17. The method of claim 12, further comprising:
receiving multiple options for the ridesharing path plan for servicing the passengers from the ridesharing service;
estimating the social cost of each of the multiple options, upon receipt of the multiple options; and
sending a request to the ridesharing service to select an option corresponding to lowest social cost.

18. The method of claim 12, further comprising sending a request to the ridesharing service to deny ridesharing requests having negative social costs.

19. The method of claim 12, further comprising:
determining credits for the ridesharing service for eliminating the second delay in the traffic; and
determining debits for the ridesharing service for causing the first delay in the traffic, such that the social cost defines a difference between credits and debits of the ridesharing service.

20. The method of claim 19, further comprising:
issuing the credits in proportion to the social cost of the ridesharing service when the social cost is negative;
issuing the debits in proportion to the social cost of the ridesharing service when the social cost is positive,
wherein the credits and debits are issued using a blockchain technology, the blockchain technology corresponds to a distributed ledger blockchain; and
assigning the credits or the debits to the ridesharing service.
